(19) United States
(12) Patent Application Publication
(10) Pub. No.: US 2018/0257259 A1
(43) Pub. Date: Sep. 13, 2018

(54) REINFORCED ADDITIVE MANUFACTURING PROCESS FOR THE MANUFACTURE OF COMPOSITE MATERIALS

(71) Applicant: Mohammad Ali Sanagooy MOHARRER, Hallam, Victoria (AU)

(72) Inventor: Mohammad Ali Sanagooy MOHARRER, Hallam, Victoria (AU)

(21) Appl. No.: 15/754,780

(22) PCT Filed: Aug. 30, 2016
(86) PCT No.: PCT/AU2016/050813

§ 371 Date: Feb. 23, 2018

(30) Foreign Application Priority Data
Aug. 31, 2015 (AU) 2015903536

(51) Int. Cl. B28B 1/00; B28B 23/00; B28B 11/24; B28B 23/04; B29C 64/106; B29D 99/00; E04C 2/06; E04C 2/22

(52) U.S. Cl. CPC B28B 1/001; B28B 23/0006; B28B 11/242; B28B 23/04; B33Y 10/00; B29D 99/0021; E04C 2/06; E04C 2/22; B29C 64/106

(57) ABSTRACT

An additive manufacturing process for the manufacture of a body from composite materials, including the steps of: providing a support structure against which the composite material is to be formed; installing a reinforcing material adjacent the support structure; and progressively applying a matrix material to the support structure to cover the reinforcing material, the matrix material being applied from a nozzle movable relative to the support structure.

### FIELD OF THE INVENTION

The present invention relates to an additive manufacturing process for the manufacture of composite materials. More particularly, but not exclusively, the present invention relates to an additive manufacturing process for the manufacture of reinforced composite building panels, roof or floor trusses and beams, columns and cladding.

### BACKGROUND OF THE INVENTION

Additive manufacturing processes such as 3D printing have been proposed and extensively used for the manufacture of many small scale items, though difficulties have been encountered in using such processes for the manufacture of larger scale items, such as building panels, which presently can be time consuming and labour intensive to form. Also, some items previously formed with 3D printing processes have lacked sufficient structural strength for use in applications having minimum strength requirements or in applications having the satisfy the relevant Building Code of Construction applicable to a construction project.

Examples of the invention seek to solve, or at least ameliorate, one or more disadvantages of previously proposed additive manufacturing processes.

### SUMMARY OF THE INVENTION

According to a first aspect of the present invention there is provided an additive manufacturing process for the manufacture of a body from composite materials, including the steps of:
providing a support structure against which the composite material is to be formed;
installing a reinforcing material adjacent the support structure; and
progressively applying a matrix material to the support structure to cover the reinforcing material, the matrix material being applied from a nozzle movable relative to the support structure.

According to a preferred embodiment of the invention, the support structure is inclined and a closing member is provided, the support structure and the closing member cooperating to form a mould cavity in which the composite material is formed. Preferably, the closing member is applied progressively as the matrix material is applied.

Preferably, the nozzle is part of a movable printing head.

The process may further include the step of bringing a shaping member into contact with the matrix material to obtain a desired surface contour. The shaping member may be in the form of a scraping tool.

The step of providing a support structure can include arranging a fabric material adjacent a support structure and applying a hardening agent to the fabric.

Preferably, the reinforcing material is formed with standoffs to maintain a separation from the support structure.

Preferably, the matrix material is heated during application. The support structure can be heated to heat the matrix material. In some embodiments, the reinforcing material conducts electricity and the matrix material is heated by applying an electrical current to the reinforcing material.

According to some embodiments, the matrix material is applied so as to encapsulate the reinforcing material.

The process can further include the step of rotating the support structure to form three dimensional objects. In some example, the support structure has a three dimensional form. In other example, the support structure is in the form of shutterings.

The support structure can be formed with recesses in which the reinforcing material can be received. In some examples, the support structure is in the form of a corrugated sheet having valleys in which the reinforcing material can be received. Preferably, the support structure is formed from a mouldable composite material. The support structure can be in the form of magnetic panelling.

The process can further include the step of prestressing the reinforcement material prior to applying the matrix material.

In some example, the composite material is in the form of a panel or truss. Such a panel can be provided with coupling means for coupling a plurality of like panels together.

Preferably, the reinforcement material is selected from a group including steel, graphene, carbon fibre or glass fibre. The reinforcement material may be a mesh or honeycomb material.

In some embodiments, the reinforcement material is applied in layers. The matrix material can include cement, polyethylene or polyurethane.

The process can further include the step of adding a filling material, which can be formed of polystyrene.

### BRIEF DESCRIPTION OF THE DRAWINGS

Preferred embodiments of the invention will be further described, by way of non-limiting example only, with reference to the accompanying drawings in which:

FIG. 1 is schematic flowchart outlining the process of one embodiment of the invention;

FIG. 2 is a perspective diagram of a body being formed using the process of one embodiment of the invention;

FIG. 3 is a side view of the body of FIG. 2; and

FIG. 4 is a perspective diagram of a body being formed using the process of another embodiment of the invention.

### DETAILED DESCRIPTION

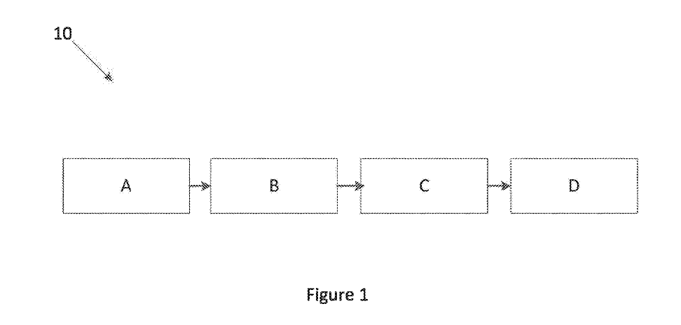

With reference to FIG. 1, there is shown schematically an additive manufacturing process for the manufacture of a body from composite materials. The process includes the following steps: (A) providing a support structure against which the composite material is to be formed; (B) installing a reinforcing material adjacent the support structure; and (C) progressively applying a matrix material to the support structure to cover the reinforcing material, the matrix material being applied from a nozzle movable relative to the support structure.

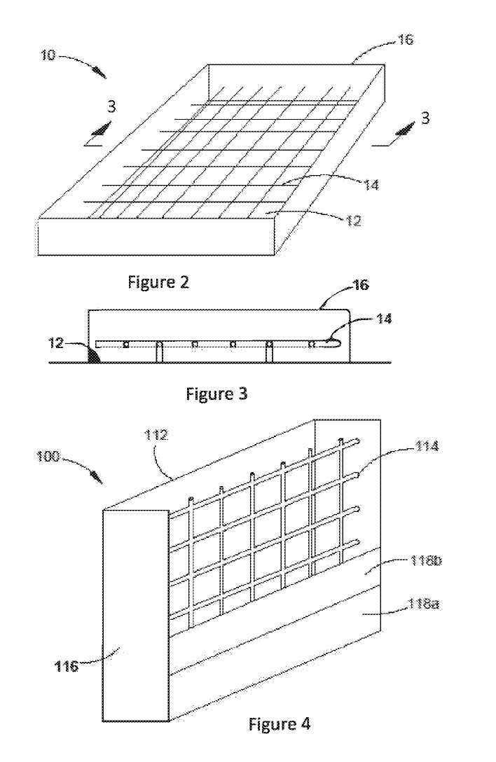

FIGS. 1 to 3 schematically illustrate in different embodiments the process of forming the body. In the examples of FIG. 1, a support structure 12 is provided in the form of a flat surface and reinforcing material 14 is installed adjacent the support structure 12. The reinforcing material 14 is in the form of a wire mesh. Although illustrated as a single layer, the reinforcing material 14 may be formed in multiple layers. Also, the or each layer may be disposed centrally within the body being formed or close to either side surface. The reinforcing material 14 is preferably formed with a plurality of deformations, as can be seen in FIG. 2. Such deformations may be formed using a punching or pressing operation to bend portions of the mesh out of the plane in which the mesh is ordinarily disposed. Forming the reinforcing material 14 in this way allows the reinforcing material 14 to remain spaced apart from the support structure 12 and encapsulated within the matrix material so as to protect the reinforcing material from destructive elements such as corrosion, heat and fire for example. Such an arrangement enables the body to be formed so as to comply with a relevant Building Code of Construction applicable to the use of the body and may also provide an aesthetically pleasing appearance. In other embodiments, the reinforcing material may be formed on the side of the body, either internally or externally, and at least partially exposed.

In the embodiments shown in FIGS. 1 to 3, the support structure 12 includes closing members or side portions 16 that cooperate with the support structure 12 to form a mould cavity, thereby maintaining the matrix material in-situ during application. It will be appreciated that the closing members 16 may take many forms and are preferably treated with an anti-stick or mould release agent to prevent the matrix material adhering to the closing members 16.

In some forms, the matrix material will be highly viscous and/or set very quickly so that closing members 16 are not required. In such embodiments, the matrix material may be smoothed or wiped during application to provide a smooth finish. Smoothing may be performed by a scraper or a roller.

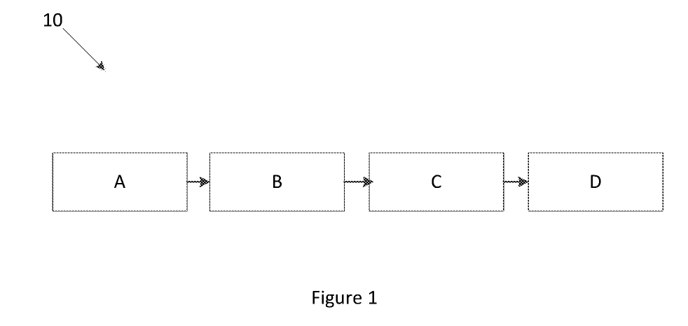

In some forms, the support structure 12 is inclined at an angle to horizontal, which will be selected having regard to the body to be formed and other process constraints. FIG. 3 illustrates the support structure 112 as being vertically disposed. Again, the reinforcing material 114 is installed adjacent the support structure 112 and the reinforcing material 114 is in the form of a wire mesh which is preferably formed with a plurality of deformations that take portions of the reinforcing material out of the a plane in which it lies, as can be seen in FIG. 3. Again, the support structure 112 includes closing members or side portions 116 that cooperate with the support structure 112 to form a mould cavity, thereby maintaining the matrix material in-situ during application. It will be appreciated that the closing members 116 may take many forms and are preferably treated with an anti-stick or mould release agent to prevent the matrix material adhering to the closing members 116. Additional closing members 118a, 188b may be provided to hold the matrix material in position during curing and may be applied progressively as the matrix material is applied.

The matrix material applied in step (C) is applied from a nozzle which is part of a movable printing head, such as a printing head of a 3D printing machine. It will be appreciated that for convenience the nozzle is movable to apply or deposit the material, though in other forms the composite material may move relative to a stationary nozzle, or both the composite material and the nozzle may move relative to each other.

The printing head preferably includes a shaping member for contouring the composite material as it is formed and the process can further include the step (D) of bringing the shaping member into contact with the matrix material to obtain a desired surface contour. In one form, the shaping member is in the form of a scraping tool. In other forms, the shaping member may be a roller or cut or otherwise machine the matrix material.

In some embodiments, in particular those in which the matrix material is built up in layers, a rotating brush may be provided to clear material build-up from the reinforcement material.

To ensure fusion between subsequent layers of the matrix material (where applicable), the matrix material may be heated during application. To this end, a heat gun using warm air, induction heating, infrared heating or UV lamps may be provided. The support structure may be heated to heat the matrix material or, in other forms such as those where the reinforcing material conducts electricity, the matrix material may be heated by applying an electrical current to the reinforcing material.

In embodiments using polymer matrix materials, the polymer may be fed to the nozzle as plastic wire or the nozzle may be part of a printing head configured for receiving plastic pallets and heat mixing them in, or in close proximity to, the printing head. In such an embodiment, the print head may include heating elements for melting the pellets and an auger for advancing the melted polymer toward the nozzle. Advantageously, polymer pellets, such as recycled polymer pellets, may be used, thereby reducing the cost of forming the body. Previously, recycled pellets have been undesirable for use in additive manufacturing processes due to their lack of accuracy, though the described process can utilise such materials due to the way the matrix material is applied.

In a preferred form the matrix material encapsulates, either completely or partially, the reinforcing material. In this regard, the matrix material may be applied and built up in layers so as to encapsulate the reinforcing material. In other forms, the matrix material may not completely encapsulate the reinforcement material to allow subsequent layers to be formed or joined together. To facilitate subsequent layers bonding together, the reinforcement may be configured for interlocking engagement with other like sections of reinforcement material.

In one form, the support structure may be in three dimensional form so that three dimensional objects can be formed. In other forms, the process can further include the step of rotating the support structure to form three dimensional objects. Advantageously, three dimensional components such as building elements may be formed, as can items such as aeroplane or helicopter bodies, boat hulls or car bodies. Also, the composite material formed by the described method may be in the form of a panel or truss having a reinforcing member encapsulated within a protective matrix material. It may also be provided with coupling means for coupling a plurality of like components together.

The support structure may take many forms and, in one example, may be in the form of shutterings. Also, the support structure may include magnetic panelling configured to be held in close proximity to the reinforcement material when in a metallic form. In other forms, the support structure may be progressively assembled as the matrix is applied so as to progressively build up a large scale object, such as a multistorey dwelling for example.

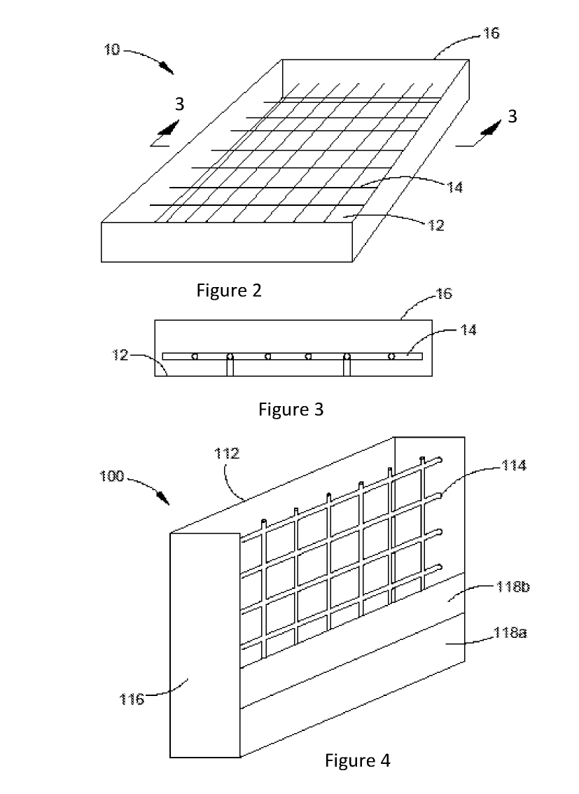

In embodiments such as that shown in FIGS. 2 and 3, the support structure 12 may be formed as a rigid member, which may be steel or wood for example. In embodiments such as that shown in FIG. 4, the support structure 112 may also be formed as a rigid member, such as steel or wood for example, though it may also be formed in situ. In this regard, the support structure 112 may be formed of a flexible material such as a fabric or film, to which a hardening agent is applied to form a rigid body for holding the matrix material in place. The hardening agent may be a curable resin or glue such as a cyanoacrylate for example, as is preferably fast acting.

Many different materials may be used for the reinforcement material, for example steel, graphene, carbon fibre or glass fibre. Fibrous materials such as jute, hemp or sisal may also be used and those skilled in the art will appreciate that many other commercially available materials may similarly be used. Also, the reinforcement material may take many forms such as rods like conventional concrete reinforcement rods, mesh or a honeycomb material, and may be in the form of metal or non-metal materials and may be a mesh or non-meshed material. In some examples, the reinforcement material is applied in layers, which may be configured for interlocking engagement with each other. The reinforcement material may be prestressing prior to applying the matrix material or post stressed after the matrix has been applied. So as to provide a composite material having the characteristics for a desired application, the reinforcement material may be prestressed/post-stressed to different degrees in different directions.

It will be appreciated that the matrix material may take many forms, such as for example, cement, plastics such as polyethylene or polyurethane, or combinations thereof. Due to contraction on cooling, polymer matrix materials are particularly useful as they interact with the reinforcement material to provide a strong body. In a preferred example, the matrix material is LDPE, which provides a formed body that can be deformed to a required shape.

The described method may also include the step of adding a filling material, such as polystyrene to fill voids in the composite material. In other forms, the support structure 12, 112 may be configured to reduce the volume of matrix material required and reduce the weight of the body formed. In one example, the support structure can include recesses, such as grooves or channels machined in the support structure, in which the reinforcing material can be received. In other examples, fillers may be applied against the support structure to occupy the volume of matrix material. In one example, the support structure is in the form of a corrugated sheet having valleys in which the reinforcing material can be received. The support structure may also have a three dimensional form to reduce the volume of matrix material required. In this regard, the support structure may be formed of a lightweight plastic or moulded paper-based product, such as paper mache for example, and may be moulded or pressed into shape during forming.

The embodiments have been described by way of example only and modifications are possible within the scope of the invention disclosed.

1-28. (canceled)

29. An additive manufacturing process for the manufacture of a body from composite materials, comprising the steps of:
providing a support structure against which the composite material is to be formed; installing a reinforcing material adjacent the support structure; and
progressively applying a matrix material to the support structure to cover the reinforcing material, the matrix material being applied from a nozzle movable relative to the support structure.

30. The process of claim 29, wherein the support structure is inclined and a closing member is provided, the support structure and the closing member cooperating to form a mould cavity in which the composite material is formed.

31. The process of claim 30, wherein the closing member is applied progressively as the matrix material is applied.

32. The process of claim 29, wherein the nozzle is part of a movable printing head.

33. The process of claim 29, further including the step of bringing a shaping member into contact with the matrix material to obtain a desired surface contour.

34. The process of claim 29, wherein the step of providing a support structure includes arranging a fabric material adjacent a support structure and applying a hardening agent to the fabric.

35. The process of claim 29, wherein the matrix material is heated during application.

36. The process of claim 35, wherein the support structure is heated to heat the matrix material.

37. The process of claim 35, wherein the reinforcing material conducts electricity and the matrix material is heated by applying an electrical current to the reinforcing material.

38. The process of claim 29, further including the step of rotating the support structure to form three dimensional objects.

39. The process of claim 29, wherein the support structure has a three-dimensional form.

40. The process of claim 39, wherein the support structure includes recesses in which the reinforcing material can be received.

41. The process of claim 40, wherein the support structure is in the form of a corrugated sheet having valleys in which the reinforcing material can be received.

42. The process of claim 39, wherein the support structure is formed from a mouldable composite material.

43. The process of claim 29, wherein the support structure is in the form of magnetic panelling.

44. The process of claim 29, wherein the composite material is in the form of a panel or truss, the panel being provided with coupling means for coupling a plurality of like panels together.

45. The process of claim 29, wherein the reinforcement material is selected from a group including steel, graphene, carbon fibre or glass fibre.

46. The process of claim 45, wherein the reinforcement material is a mesh or honeycomb material.

47. The process of claim 29, wherein the reinforcement material is applied in layers.

48. The process of claim 29, wherein the matrix material includes cement, polyethylene or polyurethane.
